(19) United States
(12) Patent Application Publication
(10) Pub. No.: US 2016/0335718 A1
(43) Pub. Date: Nov. 17, 2016

(54) CASH COLLATERAL ETF

(71) Applicant: BlackRock Fund Advisors, San Francisco, CA (US)

(72) Inventors: Thomas Callahan, Morristown, NY (US); Ira Shapiro, San Francisco, CA (US); Shannon Ghia, Corte Madera, CA (US)

(21) Appl. No.: 15/152,441

(22) Filed: May 11, 2016

Related U.S. Application Data
(60) Provisional application No. 62/159,868, filed on May 11, 2015.

(51) Int. Cl. G06Q 40/02; G06Q 40/04

(52) U.S. Cl. CPC G06Q 40/025; G06Q 40/04

(57) ABSTRACT

An exchange-traded fund (ETF) exchanges cash for a low risk security to be used as collateral. Cash is provided for purposes of posting margin in connection with a futures transaction and exchanged for shares of an ETF. The ETF permits banks to hold, as margin, a securitized version of cash (in the form of an ETF) in lieu of the margin cash posted by a client. The ETF is created or redeemed by a bank in its capacity as authorized participant, acting on behalf of a client, as collateral requirements are imposed or removed on the client. The ETF can hold a set of underlying funds in a fund-of-funds structure. Such securities may include short-term investments with specified minimum credit ratings, short term U.S. treasuries or agency securities, repurchase agreements collateralized with U.S. treasuries or agency securities, and similar minimal risk assets, which are typically government backed.

### BACKGROUND

This disclosure relates to an exchange-traded fund (ETF) that exchanges cash for a low risk security to be used as collateral. Banks hold cash and other assets for clients of the bank. A bank may serve as a futures commission merchant (FCM). A bank may also permit a client to hold assets that include some level of risk, including derivatives such as futures and options, and leveraged assets. These assets may gain or lose in excess of the market value of the assets, and therefore may expose the bank or clearinghouse to liability if the assets significantly change in value. Accordingly, the client holding certain high-risk types of financial instruments may be required by the bank to post margin, generally in the form of cash collateral, to account for these risks and to ensure that both parties fulfill their obligations.

However, in some market environments and pursuant to certain regulatory reserve requirements, holding cash for a client may trigger capital holding requirements for a bank. For example, under guidelines published by the Basel Committee on Banking Supervision (“Basel III”), cash collateral may trigger additional capital holding requirements for a bank. Thus, when a client posts cash as collateral to fulfill collateral obligations, it may affect the bank's capital requirements.

### SUMMARY

Cash collateral is exchanged for shares of an ETF that is used instead as collateral for high-risk assets in a client's account in a bank. Cash is provided for purposes of posting margin in connection with a futures (or other derivative) transaction and exchanged for shares of an ETF. The ETF permits banks to hold, as margin, a securitized version of cash (in the form of an ETF) in lieu of the margin cash posted by a client. Though described here as an ETF, additional types of investment funds to securitize cash and generate a cash-equivalent asset may also be used. The ETF is created or redeemed by a bank in its capacity as authorized participant, acting on behalf of its client, as collateral requirements are imposed or removed on the client. In one embodiment, the ETF is created or redeemed by a bank in its capacity as authorized participant after margin cash has already been posted and is being held in the collateral account, rather than based on collateral requirements being imposed or removed. The ETF is managed by a fund manager, and in one embodiment holds a set of underlying funds in a fund-of-funds structure. Each underlying fund of the ETF holds securities that are subject to the requirements of Rule 2a-7 under the Investment Company Act of 1940, as amended, and are expected to have a constant net asset value. Such securities may include short-term investments with specified minimum credit ratings, short term U.S. treasuries or agency securities, repurchase agreements collateralized with U.S. treasuries or agency securities, and similar minimal risk assets, which are typically government backed. These are described further below.

### BRIEF DESCRIPTION OF THE DRAWINGS

FIG. 1 illustrates a system allowing a bank to exchange collateral cash received from a client for a security, in accordance with some embodiments.

FIG. 2 illustrates an asset flow to convert cash collateral to an ETF, in accordance with some embodiments.

FIG. 3 is a flowchart for exchanging cash received as collateral for an underlying transaction, in accordance with some embodiments.

### DETAILED DESCRIPTION

### Overview

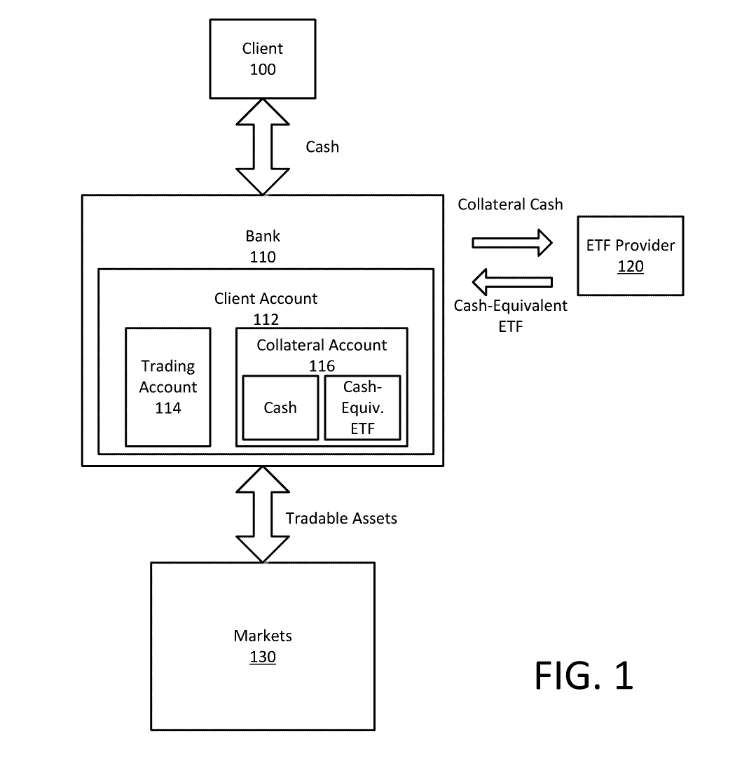

FIG. 1 illustrates a system allowing a bank to exchange cash into a low risk security received from a client as collateral for a transaction, in accordance with some embodiments. The client 100 can be an individual investor or an institutional investor that has an account with a bank 110. The bank 110 holds assets for the client 100, such as securities, cash, and derivatives. In some embodiments, the bank 110 is a futures commission merchant (FCM) and permits the client 100 to enter into a futures contract or some other derivative transaction. The bank 110 may require the client to post collateral to cover a transaction if the transaction exposes the bank 110 to liability beyond the value of the asset the client 100 received in the transaction. In some cases, the downside risk of a transaction is not accounted for by the cost of the transaction. For example, in the transaction a client may sell an option or other contract or derivative contingent on the price of another security, such that the transaction exposes the client to liability beyond the sale price of the transaction. The client 100 holds assets in a client account 112 in the bank 110. The client account 112 may include a trading account 114 that designates assets held by the client account 112, including assets that present risks and require collateral to be posted by the client 100 as noted above. The trading account 114 may purchase or sell assets to various markets 130. Various accounts are designated herein as relating to the client account 112, such as the trading account 114. These accounts may be sub-accounts of the client account 112, and may be separately designated to the client 100, or may only be presented to the client with respect to requirements on the client, for example to designate which assets are held as collateral, or which assets are available for trade.

A collateral account 116 maintains collateral that may be required by activity in the trading account 114. The bank 110 may enforce the collateral requirements prior to permitting a transaction in the trading account 114 that would require the collateral, or the bank 110 may enforce the collateral requirements soon after the transaction (i.e., when the transaction is committed to by the client, and the amount of required collateral can be determined). The collateral account 116 receives cash from the client 100 as an initial margin amount. Subsequently, a client submits an order to the bank's equity trading/authorized participant desk (“trading desk”), which then places an order with an ETF provider 120 to create shares of an ETF that can be used as collateral instead of the cash received from the client. The ETF provider 120 fulfills orders on the primary market for the ETF (e.g. creation and redemption orders). For example, the ETF provider 120 may ensure that sufficient cash was received for a creation order and may ensure that the correct number of ETF shares are assigned to the entity that placed the creation order (in this case, the bank 110). The bank 110 transfers cash to the ETF provider 120 to settle shares of the ETF and the ETF provider 120 transfers the shares of the ETF to the bank 110 in exchange for the cash in the collateral account 116. In one embodiment, rather than holding the collateral account 116 at the bank 110, the collateral is held at a central clearinghouse (not shown) responsible for ensuring the underlying transaction is collateralized and may hold the collateral until the underlying transaction no longer requires collateralization.

At the ETF provider 120, the ETF provider receives the cash from the bank and issues shares of the ETF to the bank's trading desk. The ETF provider 120 uses cash to acquire the underlying assets for the fund. The assets may include:
U.S. dollar-denominated short-term investments that, at the time of acquisition, are rated as low-risk investments, (e.g. A-1, F1 or P-1), or if unrated, determined by the fund manager of the ETF to be equivalent in risk quality;
Fixed-rate low-risk government debt instruments (e.g. U.S. Treasury and agency securities) with a remaining maturity of 397 days or less;
Floating-rate low-risk government debt instruments (e.g. U.S. Treasury and agency securities);
Repurchase agreements collateralized with low-risk government debt instruments (e.g. U.S. Treasury or agency securities); and
Mutual funds with equivalent low-risk holdings, such as money market funds, that the fund manager determines have objectives and characteristics consistent with the ETF.

The underlying assets of the ETF provide a similar minimal level of risk to the collateral cash and may be effectively relied on by the bank 110 as a safe security for posting as collateral. In one embodiment, rather than directly investing in such assets, the ETF provider 120 acquires a set of funds which, themselves, invest in the assets. By exchanging the collateral cash for an exchange-traded fund having similar risk characteristics as the cash, the bank 110 continues to hold collateral for trading activity of the client 100, but without impacting its cash capital holding requirements.

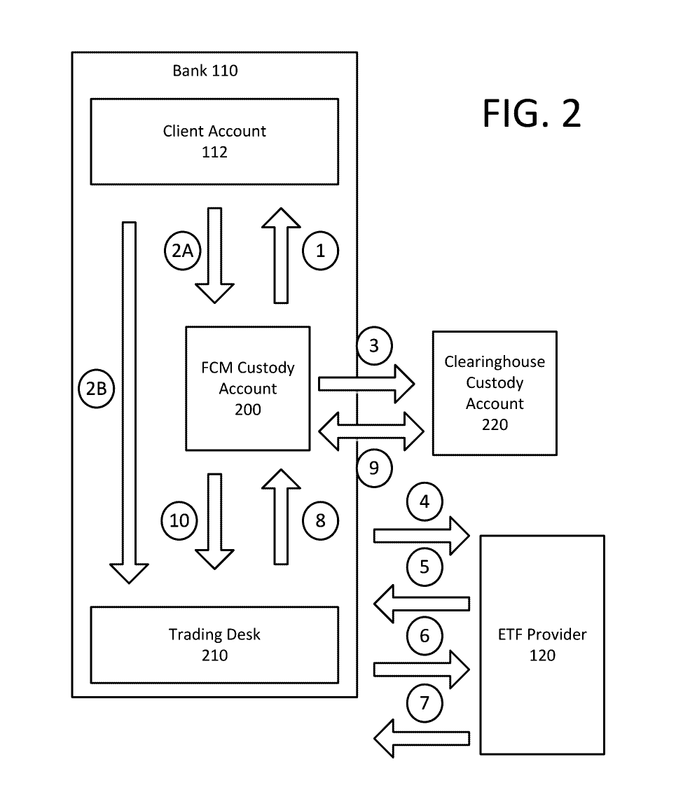

FIG. 2 illustrates an asset flow to convert cash collateral to an ETF, in accordance with some embodiments. In this embodiment, the cash collateral (which may be netted with respect to multiple clients) is provided to a clearinghouse custody account 220. In other embodiments, not shown in FIG. 2, the collateral is maintained in an FCM custody account 200. In the example illustrated in FIG. 2, the FCM custody account 200 determines collateral requirements and solicits such collateral from a client's account 112. The trading desk 210 is a trading system, such as an equity trading/authorized participant desk, that interfaces with other systems to exchange obligations for assets with external systems, and is an authorized participant with respect to the ETF that may interact directly with the ETF provider 120 to create or redeem shares of the ETF. In this example process, each step is denoted by a circle in FIG. 2. The processes may be initiated on an initial trading day, T, when the client performs the underlying transaction. Steps 1-4 may be performed on the initial trading day, T, while steps 5-10 may be performed on the subsequent trading day, T+1, as further noted below:

Day T
1. In the initial step, when the client account performs a transaction that requires collateral to cover the transaction (i.e. “underlying transaction”), the FCM custody account 200 identifies that additional collateral is required, for example by receiving a transaction request initiated by the client. The FCM custody account 200 notifies the client of the required collateral.
2. Next, the client informs the custodian to post the collateral cash through an ETF. The quantity and value of the shares to purchase may be determined by the bank 100 or via the trading desk 210 and correspond to the amount of collateral provided by the client.
   2A. If collateral is required for the underlying transaction, the bank 100 moves cash from the client account to the FCM custody account 200.
   2B. Additionally, instructions are sent by the client to the trading desk 210 to acquire the requisite number of shares of the ETF that may be used instead of the cash collateral.
3. Next, to collateralize the obligation on the day of the underlying transaction (such that the identified obligation is always collateralized), the FCM custody account 200 posts the collateral to the clearinghouse custody account 220.
4. To initiate the ETF creation, the trading desk 210 places an ETF creation order with the ETF provider 120 by acting as an authorized participant with respect to the ETF. In one embodiment, the trading desk 210 aggregates orders to create shares of the ETF across many clients of the bank 100, and may delay the order to the end of day to aggregate orders.

Day T+1
5. The ETF provider 120 indicates the amount owed for the requested ETF shares to the trading desk 210.
6. Next, the trading desk 210 transmits the cash amount owed to the ETF provider 120. In this example, the trading desk 210 provides its own cash to create shares of the ETF until the ETF shares can be used to collateralize the obligation at step 9, thereby releasing the collateral cash provided by the client from the requirement to act as collateral.
7. Next, the ETF shares settle at the trading desk's 210 account. In some embodiments, the ETF shares are held in the client's name in the trading desk's 210 account.
8. The ETF shares are transferred (journaled) to the FCM custody account 200 from the trading desk 210. In some embodiments, the ETF shares are held in the client's name in the FCM custody account 200.
9. The FCM custody account 200 posts the ETF shares to the clearinghouse custody account 220 in exchange for the cash previously posted at step 3. At this point, the obligation for collateral at the clearinghouse is satisfied by the ETF shares, rather than by the cash. In some embodiments, the ETF shares are held in the client's name while held at the clearinghouse.
10. Finally, to recover the cash originally exchanged to create the ETF shares, the FCM custody account 200 sends the recovered cash collateral to the trading desk 210.

As a result of these transactions, the ETF shares (in the client's name) are posted as collateral to the clearinghouse custody account 220 to collateralize the obligation of the client account 112 and may be used in exchange for the originally posted collateral cash. In alternatives, the cash-equivalent ETF shares may be held at the FCM custody account 200 rather than at the clearinghouse custody account 220.

Though described above as being performed on trading days T and T+1, in other embodients, the steps may be performed on different trading days than those noted above. For example, in one embodiment all of the steps are completed on day T. In other embodiments, the steps may be split among T and T+1 in a different way that described above, or may be spread to additional days, such as T+2, T+3, or more, for example depending on the settlement dates of the various steps.

In alternate embodiments, instead of or in addition to acquiring the ETF shares by placing a creation order with the ETF provider 120, the trading desk 210 purchases the ETF shares on the secondary market. In some embodiments, the trading desk 210 will compare the price of purchasing the ETF shares on the primary market and on the seconday market, and will purchase from the market with the lower price per ETF share.

When collateral is no longer required, these steps may be reversed to return cash to a client's account. The value of the collateral that may be released to a client may be determined by the clearinghouse or FCM custody account 200, and the corresponding number of ETF shares is returned to the FCM custody account 200 by the clearinghouse custody account 220. The ETF shares are sent (journaled) to the trading desk 210 and redeemed with the ETF provider 120 by the trading desk 210 operating as an authorized participant with the ETF. When cash is returned from the ETF Provider 120 to the trading desk 210, that cash may be returned to the client account 112.

Exchanging Cash into a Security to be used for Collateral

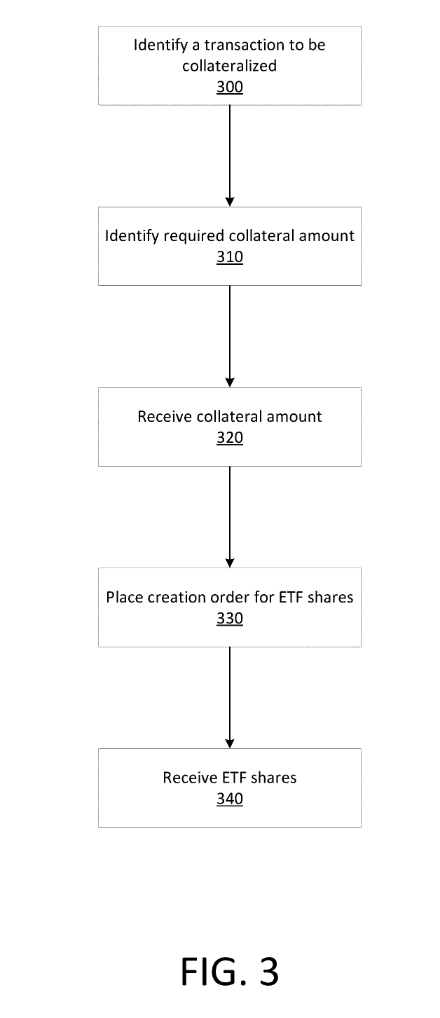

FIG. 3 is a flowchart for exchanging cash received into a security to be used as collateral for an underlying transaction, in accordance with some embodiments.

The bank identifies 300 an underlying transaction that exposes the bank to liability beyond the valueof the asset received by the client in the underlying transaction. The bank identifies 310 a required collateral amount of cash for the underlying transaction and receives 320 the collateral amount from the client. The collateral amount of cash serves as collateral for the underlying transaction and may be subject to reserve requirements requiring the bank to hold additional capital. In some embodiments, the bank sends the collateral cash amount to a clearinghouse to post as collateral for the underlying transaction.

The bank places 330 a creation order with an ETF provider to create ETF shares corresponding to the collateral cash amount. The ETF comprises underlying assets with a similar minimal level of risk to the collateral cash amount, such as short-term investments that are rated as low-risk investments, fixed-rate low-risk government debt instruments, floating-rate low-risk government debt instruments, and repurchase agreements collateralized with low-risk government debt instruments. In some embodiments, the ETF comprises a set of funds which are each invested in low-risk assets, such as the ones listed above. Additionally, the bank may aggregate collateral cash from a plurality of clients and may place a creation order for ETF shares in exchange for the aggregated collateral cash amounts.

The bank receives 340 the ETF shares from the ETF provider, where the ETF shares serve as collateral for the underlying transaction and may not be subject to the reserve requirements for the bank to hold additional capital. In some embodiments, the bank sends the ETF shares to a clearinghouse in exchange for the collateral cash amount, where the ETF shares serve as collateral for the underlying transaction instead of the collateral cash amount. In some embodiments, the ETF shares are received on a day after the day on which the creation order was placed with the ETF provider (e.g. the next day). In other embodiments, the ETF shares are received on the same day as the day on which the creation order was placed with the ETF provider.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describes the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
identifying an underlying transaction by a client, the underlying transaction exposing a bank to liability beyond a value of an asset received in the underlying transaction;
identifying a required collateral cash amount for the underlying transaction;
receiving, at the bank, the collateral cash amount from the client, the collateral cash amount serving as collateral for the underlying transaction and being subject to reserve requirements requiring the bank to hold additional capital;
placing a creation order with an ETF provider to create ETF shares corresponding to the collateral cash amount, the ETF comprising underlying assets with a similar minimal level of risk to the collateral cash amount; and
receiving the ETF shares from the ETF provider, the ETF shares serving as collateral for the underlying transaction and not being subject to the reserve requirements.

2. The method of claim 1, further comprising:
sending the collateral cash amount to a clearinghouse to post as collateral for the underlying transaction; and
responsive to receiving the ETF shares from the ETF provider, sending the ETF shares to the clearinghouse in exchange for the collateral cash amount, the ETF shares acting as collateral for the underlying transaction instead of the collateral cash amount.

3. The method of claim 1, wherein the underlying assets of the ETF comprise at least one of: short-term investments that are rated as low-risk investments; fixed-rate low-risk government debt instruments; floating-rate low-risk government debt instruments; and repurchase agreements collateralized with low-risk government debt instruments.

4. The method of claim 1, wherein the ETF comprises a set of funds which each invest in low-risk assets.

5. The method of claim 1, wherein the ETF shares are received and the creation order is placed on the same day

6. The method of claim 1, wherein the creation order is placed on a first day and the ETF shares are received on a second day, wherein the second day is after the first day.

7. The method of claim 6, wherein the second day is directly after the first day.

8. The method of claim 1, further comprising:
receiving a plurality of collateral cash amounts from a plurality of clients through a plurality of clients;
aggregating the plurality of collateral cash amounts into an aggregated collateral cash amount; and
placing a creation order with the ETF provider to create ETF shares in exchange for the aggregated collateral cash amount.

9. A computer program product comprising a non-transitory computer-readable storage medium comprising instructions encoded thereon that, when executed by a processor, cause the processor to:
identify an underlying transaction by a client, the underlying transaction exposing a bank to liability beyond a value of an asset received in the underlying transaction;
identify a required collateral cash amount for the underlying transaction;
receive, at the bank, collateral cash amount from the client, the collateral cash amountserving as collateral for the underlying transaction and being subject to reserve requirements requiring the bank to hold additional capital;
place a creation order with an ETF provider to create ETF shares corresponding to the collateral cash amount, the ETF comprising underlying assets with a similar minimal level of risk to the collateral cash amount; and
receive the ETF shares from the ETF provider, the ETF shares serving as collateral for the underlying transaction and not being subject to the reserve requirments.

10. The computer program product of claim 9, further comprising instructions to:
send the collateral cash amount to a clearinghouse to post as collateral for the underlying transaction; and
responsive to receiving the ETF shares from the ETF provider, send the ETF shares to the clearinghouse in exchange for the collateral cash amount, the ETF shares acting as collateral for the underlying transaction instead of the collateral cash amount.

11. The computer program product of claim 9, wherein the underlying assets of the ETF comprise at least one of: short-term investments that are rated as low-risk investments; fixed-rate low-risk government debt instruments; floating-rate low-risk government debt instruments; and repurchase agreements collateralized with low-risk government debt instruments.

12. The computer program product of claim 9, wherein the ETF comprises a set of funds which each invest in low-risk assets.

13. The computer program product of claim 9, wherein the ETF shares are received and the creation order is placed on the same day.

14. The computer program product of claim 9, wherein the creation order is placed on a first day and the ETF shares are received on a second day, wherein the second day is after the first day.

15. The computer program product of claim 14, wherein the second day is directly after the first day.

16. The computer program product of claim 9, further comprising instructions to:
receive a plurality of collateral cash amounts from a plurality of clients through a plurality of clients;
aggregate the plurality of collateral cash amounts into an aggregated collateral cash amount; and
place a creation order with the ETF provider to create ETF shares in exchange for the aggregated collateral cash amount.
